(19) United States
(12) Patent Application Publication
(10) Pub. No.: US 2009/0191343 A1
(43) Pub. Date: Jul. 30, 2009

(54) Method for printing decorative member

(75) Inventor: Ming Tsung Wang, Changhua (TW)

Correspondence Address: CHARLES E. BAXLEY, ESQUIRE, 90 JOHN STREET, SUITE 309, NEW YORK, NY, 10038, US

(73) Assignee: Aiska International Co., Ltd.

(21) Appl. No.: 12/012,172

(22) Filed: Jan. 30, 2008

(51) Int. Cl. B05D 3/00

(52) U.S. Cl. 427/299

(57) ABSTRACT

A method for forming a decorative member includes applying a resilient layer onto a basic layer, applying a printing layer onto the resilient layer, applying another resilient layer onto the printing layer for forming a layered element, forming the layered element into a three-dimensional element, shaping the three-dimensional element into a prototype, and applying a protective layer onto the prototype for covering and shielding and protecting the prototype. The layered element may be disposed in a mold device for heating and vacuumming the layered element, or may be disposed between two mold pieces of a mold device for being formed into the three-dimensional element with the mold pieces of the mold device.

### BACKGROUND OF THE INVENTION

1. Field of the Invention

The present invention relates to a method for printing and shaping a decorative member, and more particularly to a method for printing a decorative pattern onto a decorative member and for shaping the decorative member into a spatial or three-dimensional object.

2. Description of the Prior Art

Typical decorative placemat constructions comprise a compliant opaque backer sheet formed of foamed polyvinyl chloride, and a clear transparent overlay sheet disposed over the backer and secured on three sides by such as thermowelding, to fuse the contiguous backer and overlay plastic materials.

For example, U.S. Pat. No. 3,920,870 to Ackerman et al. discloses one of the typical decorative placemat constructions comprising a graphic pattern insert inserted between the backer and overlay, and enclosed by securing a flap-like member affixed to the overlay to the backer sheet, and a double sided acrylic copolymer adhesive strip is advantageously utilized to secure the flap and the backer sheet.

However, normally, the typical decorative placemat constructions may only be inserted with the planar graphic pattern insert, but may not be formed or shaped into a spatial or three-dimensional structure.

U.S. Pat. No. 5,048,417 to Everroad discloses a typical compact apparatus for screen perparation and printing and for operating all of the steps of a screen printing process at a single, space-saving work station.

However, similarly, the typical compact apparatus may only be used for printing the planar members which may not be formed or shaped into a spatial or three-dimensional structure.

The present invention has arisen to mitigate and/or obviate the afore-described disadvantages of the conventional methods for printing and shaping the decorative members.

### SUMMARY OF THE INVENTION

The primary objective of the present invention is to provide a method for printing a decorative pattern onto a decorative member and for shaping the decorative member into a spatial or three-dimensional object.

In accordance with one aspect of the invention, there is provided a method for forming a decorative member comprising providing and preparing a basic layer, applying a first resilient layer onto the basic layer, applying a printing layer onto the first resilient layer, applying a second resilient layer onto the printing layer for forming a layered element, forming the layered element into a three-dimensional element, shaping the three-dimensional element into a prototype, and applying a protective layer onto the prototype for covering and shielding and protecting the prototype.

The protective layer may be applied onto such as the basic layer of the prototype.

The layered element may be disposed in a mold device for vacuumming and heating the layered element and for forming the layered element into the three-dimensional element.

The three-dimensional element includes a burred outer peripheral portion machined to form the three-dimensional element into the prototype.

The layered element may also be disposed between two mold pieces of a mold device for being formed into the three-dimensional element with the mold pieces of the mold device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a decorative member to be printed and shaped with a method in accordance with the present invention;

FIG. 2 is an exploded view illustrating the layers of the decorative member;

FIG. 3 is another plan schematic view illustrating the layers of the decorative member;

FIG. 4 is a further plan schematic view illustrating the forming or the shaping of the decorative member;

FIG. 5 is a still further plan schematic view illustrating the further forming or the shaping of the decorative member;

FIG. 6 is a partial exploded view illustrating the mold device for forming or shaping the decorative member;

FIG. 7 is a plan schematic view of the mold device for forming or shaping the decorative member; and

FIG. 8 is a still further plan schematic view illustrating the prototype of the decorative member.

### DETAILED DESCRIPTION OF THE PREFERRED EMBODIMENT

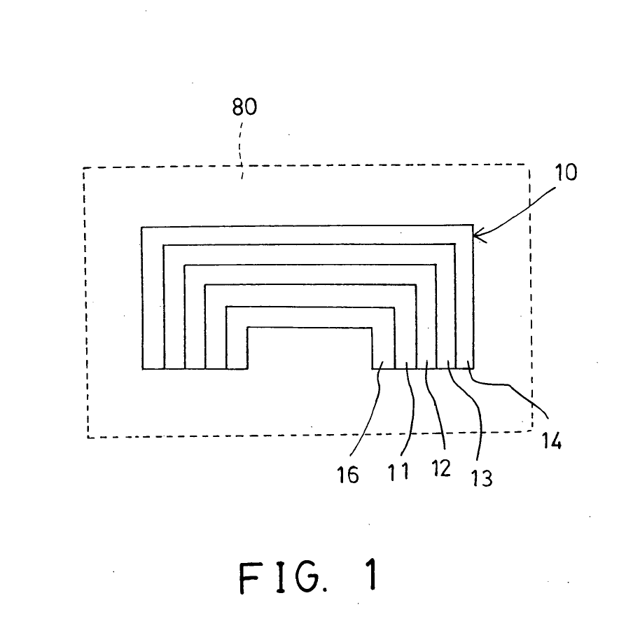

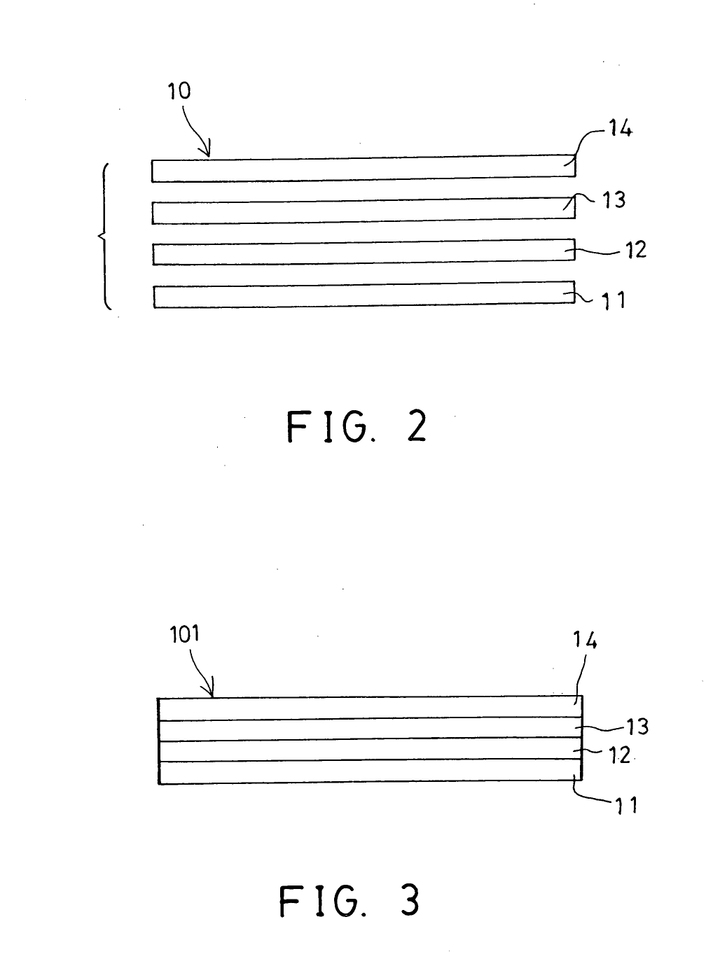

Referring to the drawings, and initially to FIGS. 1-5, a decorative member 10 is provided and to be printed and shaped with a method in accordance with the present invention, in which the decorative member 10 comprises a basic sheet or film or membrane or layer 11 made of such as poly carbonate or plastic materials, a soft or resilient material or layer 12 painted or printed or attached or applied onto the basic layer 11, a painting or printing layer 13 painted or screen printed or attached or applied onto the resilient layer 12 and having a decorative pattern formed or provided on the painting or printing layer 13, and another resilient material or layer 14 further provided and painted or printed or attached or applied onto the printing layer 13 for forming a layered or sheet-like element 101 as shown in FIG. 3, in which the layered or sheet-like element 101 is flexible or resilient.

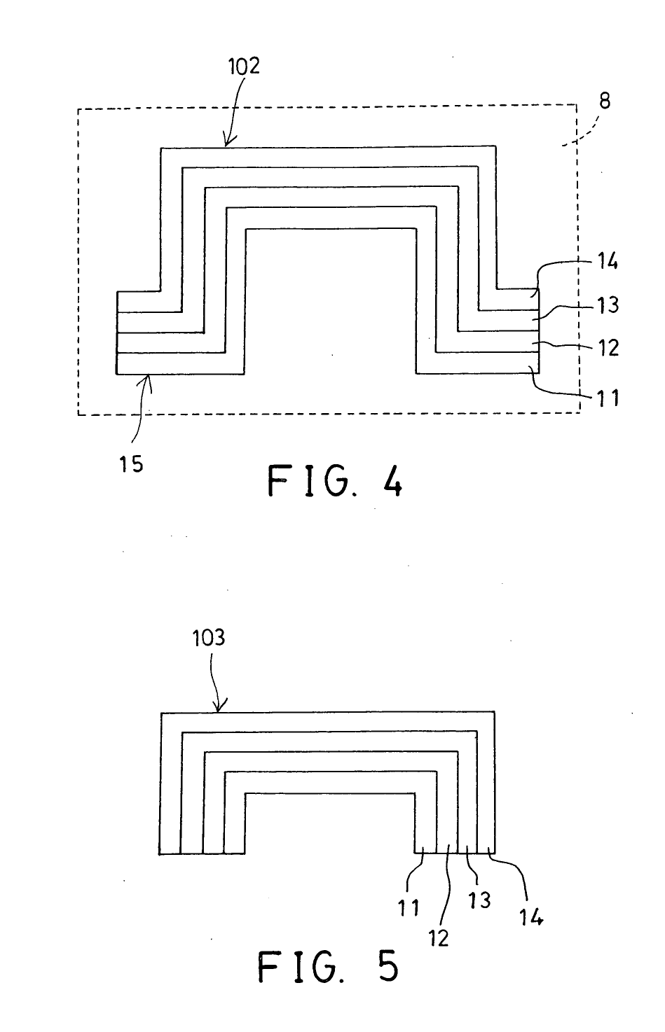

As shown in FIG. 4, the layered or sheet-like element 101 is then disposed in a mold device 8 for vacuumming and heating the layered or sheet-like element 101 and for shaping the layered or sheet-like element 101 into a spatial or three-dimensional object or element 102, and the resilient layers 12, 14 will be heated and hardened and maintained in the selected or required shape, and the spatial or three-dimensional object or element 102 may include a burred outer peripheral portion or flange 15 which may then be cut or machined or ground off from the spatial or three-dimensional object or element 102 for forming or shaping the spatial or three-dimensional object or element 102 into a prototype 103 as shown in FIG. 5.

The prototype 103 is then disposed in a machine or another mold device 80 as shown in FIG. 1, for painting or printing or attaching or applying a protective or plastic layer 16 onto the outer peripheral portion of the prototype 103, such as applying the protective or plastic layer 16 onto the outer peripheral portion of the basic layer 11 for covering and shielding and protecting the basic layer 11 and thus for forming the shaped and spatial or three-dimensional decorative member 10. The provision of the resilient layers 12, 14 on the lower and the upper sides of the printing layer 13 allows the printing layer 13 to be suitably formed and shaped and sandwiched and protected between the resilient layers 12, 14 while vacuumming and heating the layered or sheet-like element 101.

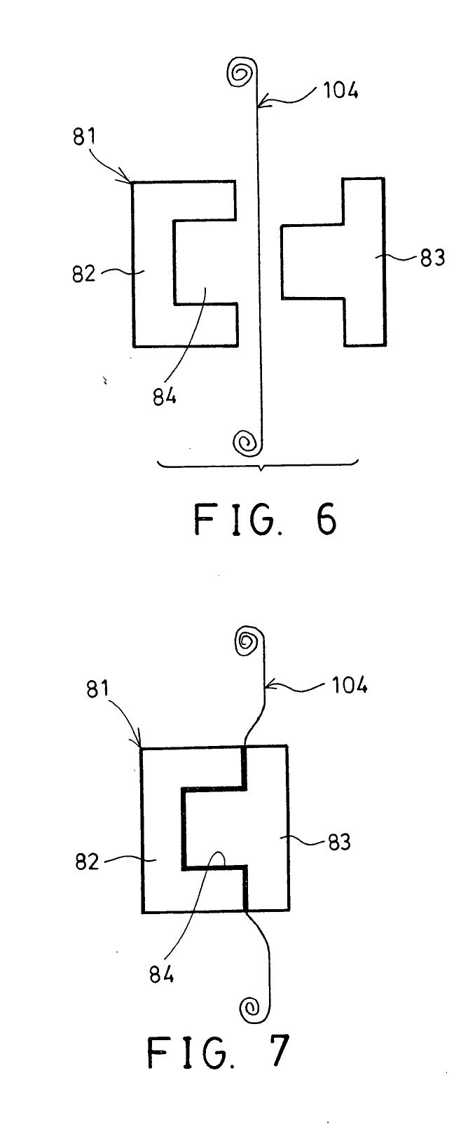

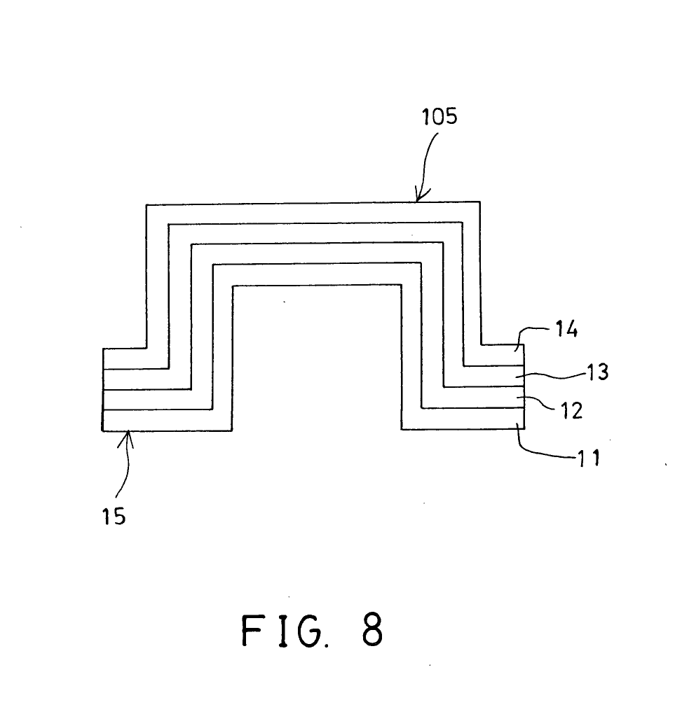

Alternatively, as shown in FIGS. 6 and 7, the layered or sheet-like element 104 may be formed into a longitudinal structure and may be wound or folded into one or more folds, and the layered or sheet-like element 104 may then be engaged through or into a further mold device 81, such as disposed between two mold pieces 82, 83 of the mold device 81, in which one of the mold pieces 82 may include a mold cavity 84 formed therein and having the outer contour or structure corresponding to that of the decorative member 10 to be formed and shaped. The layered or sheet-like element 104 may thus be formed into a spatial or three-dimensional object or element 105 as shown in FIG. 8 instead of the mold device 8 or without the mold device 8 as shown in FIG. 4.

The spatial or three-dimensional object or element 105 may also include a burred outer peripheral portion or flange 15 which may then be cut or machined or ground off from the spatial or three-dimensional object or element 105 for forming or shaping the spatial or three-dimensional object or element 105 into the prototype 103 as shown in FIG. 5 before the protective or plastic layer 16 is applied onto the outer peripheral portion of the basic layer 11 of the prototype 103. It is to be noted that, typically, the typical decorative members may only be formed into a planar structure but may not be formed or shaped into a spatial or three-dimensional structure.

Accordingly, the method in accordance with the present invention may be provided for printing a decorative pattern onto a decorative member and for shaping the decorative member into a spatial or three-dimensional object.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for forming a decorative member comprising:
providing and preparing a basic layer,
applying a first resilient layer onto said basic layer,
applying a printing layer onto said first resilient layer,
applying a second resilient layer onto said printing layer for forming a layered element,
forming said layered element into a three-dimensional element,
shaping said three-dimensional element into a prototype, and
applying a protective layer onto said prototype for covering and shielding and protecting said prototype.

2. The method as claimed in claim 1, wherein said protective layer is applied onto said basic layer of said prototype.

3. The method as claimed in claim 1, wherein said layered element is disposed in a mold device for vacuumming and heating said layered element and for forming said layered element into said three-dimensional element.

4. The method as claimed in claim 1, wherein said three-dimensional element includes a burred outer peripheral portion machined to form said three-dimensional element into said prototype.

5. The method as claimed in claim 1, wherein said layered element is disposed between two mold pieces of a mold device for being formed into said three-dimensional element with said mold pieces of said mold device.
